(19) United States
(12) Patent Application Publication
(10) Pub. No.: US 2025/0300740 A1
(43) Pub. Date: Sep. 25, 2025

(54) OPTICAL TRANSMISSION DEVICE, OPTICAL COMMUNICATION SYSTEM AND OPTICAL TRANSMISSION METHOD

(71) Applicant: NIPPON TELEGRAPH AND TELEPHONE CORPORATION, Tokyo (JP)

(72) Inventors: Ryo KOMA, Musashino-shi (JP); Kazutaka HARA, Musashino-shi (JP); Junichi KANI, Musashino-shi (JP)

(73) Assignee: NIPPON TELEGRAPH AND TELEPHONE CORPORATION, Tokyo (JP)

(21) Appl. No.: 18/861,684

(22) PCT Filed: May 10, 2022
(86) PCT No.: PCT/JP2022/019832

§ 371 Date: Oct. 30, 2024

(51) Int. Cl. H04B 10/516; H04B 10/60

(52) U.S. Cl. CPC H04B 10/5161; H04B 10/60

(57) ABSTRACT

Provided is an optical transmission device including: a modulation signal generation unit that generates an intensity modulation signal and a continuous phase frequency shift keying (CPFSK) signal; a light source that outputs a signal modulated by the CPFSK signal; and an intensity modulation unit that performs intensity modulation for canceling an intensity modulation component generated by modulation by the CPFSK signal, and intensity modulation by the intensity modulation signal, on the signal output from the light source.

### TECHNICAL FIELD

The present invention relates to an optical transmission device, an optical communication system, and an optical transmission method.

### BACKGROUND ART

Currently, in an optical subscriber line network, to economically provide high-speed communication services to users, there is provided a system called a PON system in which a plurality of subscriber devices (ONUs) shares a part of optical fiber transmission lines and a station side device (OLT).

For example, Non Patent Literature 1 proposes an all photonics network (APN) as a future network. The APN is assumed to be accommodated in an optical direct connection network in which photoelectric conversion and electrical routing processing on a path are eliminated as much as possible in communication between users.

In the optical direct connection network, it is a problem to increase the speed and the transmission distance while keeping the ONU in a simple and economical configuration, common to both the OLT and the ONU.

As a means for solving this problem, Non Patent Literature 2 proposes a method of using an EA modulator integrated direct modulation diode on the ONU side. In the proposed method, an ONU generates a signal subjected to continuous phase frequency shift keying (CPFSK) by using the EA modulator integrated direct modulation diode in uplink communication, and transmits the modulated signal.

Non Patent Literature 3 proposes a communication method using an EA modulator integrated direct modulation diode in an APN. In the proposed communication method, in communication between devices in a short distance, an intensity modulation (IM) signal is transmitted and received, and direct communication is performed using a return function of a photonic gateway (PhGW) that is an optical node of the APN. On the other hand, in communication between devices in a long distance, a CPFSK signal is used in communication with a repeater.

As a method for speeding up the CPFSK signal, Non Patent Literature 4 proposes a configuration for improving a multilevel degree of a signal applied to a direct modulation laser and improving the number of information bits that can be transmitted in one symbol.

### CITATION LIST

### Non Patent Literature

Non Patent Literature 1: Kawahara et al., NTT Technical Journal, Vol. 32 No. 3, 2020, pp. 14-21.
Non Patent Literature 2: M. Fujiwara, R. Koma, J.-i. Kani, K.-I. Suzuki and A. Otaka, “Performance evaluation of CPFSK transmitters for TDM-based digital coherent PON upstream”, 2017 Optical Fiber Communications Conference and Exhibition (OFC), 2017, pp. 1-3.
Non Patent Literature 3: R. Koma, K. Hara, T. Kanai, J.-i. Kani and T. Yoshida, “Novel EA-DFB Mode-Switching Transmitter Supporting Continuous Phase Frequency Shift Keying and Intensity Modulation for All-Photonics Network”, 2021 European Conference on Optical Communication (ECOC), 2021, pp. 1-4, doi: 10.1109/ECOC52684.2021.9605834.
Non Patent Literature 4: D. Che, F. Yuan, Q. Hu and W. Shieh, “Frequency Chirp Supported Complex Modulation of Directly Modulated Lasers”, in Journal of Lightwave Technology, vol. 34, no. 8, pp. 1831-1836, 15 Apr. 15, 2016, doi: 10.1109/JLT.2015.2512298.

### SUMMARY OF INVENTION

### Technical Problem

However, since the technique of speeding up proposed by Non Patent Literature 4 is speeding up in a phase direction, a distance between signal points decreases when a high multilevel degree is set, similarly to a multilevel PSK modulation. For that reason, a required signal to noise ratio (SNR) for securing a signal quality increases. Although it is conceivable to prevent SNR degradation by an M-value quadrature amplitude modulation scheme (M-QAM scheme), there is a disadvantage that an intensity modulation component accompanying CPFSK signal generation degrades SNR because a frequency modulation signal is generated by a direct modulation laser.

In view of the above circumstances, an object of the present invention is to reduce degradation of a CPFSK signal and increase a transmission speed.

### Solution to Problem

An aspect of the present invention is an optical transmission device including: a modulation signal generation unit that generates an intensity modulation signal and a continuous phase frequency shift keying (CPFSK) signal; a light source that outputs a signal modulated by the CPFSK signal; and an intensity modulation unit that performs intensity modulation for canceling an intensity modulation component generated by modulation by the CPFSK signal, and intensity modulation by the intensity modulation signal, on the signal output from the light source.

An aspect of the present invention is an optical communication system including: an optical transmission device including: a modulation signal generation unit that generates an intensity modulation signal and a continuous phase frequency shift keying (CPFSK) signal; a light source that outputs a signal modulated by the CPFSK signal; and an intensity modulation unit that performs intensity modulation for canceling an intensity modulation component generated by modulation by the CPFSK signal, and intensity modulation by the intensity modulation signal, on the signal output from the light source; and an optical reception device including: a reception unit that performs polarization separation and phase separation on a signal received from the optical transmission device; and a signal processing unit that decodes the intensity modulation signal and the CPFSK signal on the basis of signals subjected to the polarization separation and the phase separation.

An aspect of the present invention is an optical transmission method including: a modulation signal generation step of generating an intensity modulation signal and a continuous phase frequency shift keying (CPFSK) signal; an output step of outputting a signal modulated by the CPFSK signal; and an intensity modulation step of performing intensity modulation for canceling an intensity modulation component generated by modulation by the CPFSK signal, and intensity modulation by the intensity modulation signal, on the signal output from the light source.

### Advantageous Effects of Invention

According to the present invention, the degradation of the CPFSK signal can be reduced to increase the transmission speed.

### BRIEF DESCRIPTION OF DRAWINGS

FIG. 1 is a diagram illustrating an example of a configuration of an optical communication system 1 according to a first embodiment.

FIG. 2 is a diagram illustrating an example of a configuration of an optical transmission device 2 according to the first embodiment.

FIG. 3 is a diagram illustrating an electric field of a signal generated by a light source 24.

FIG. 4 is a diagram illustrating an electric field of a signal output by an intensity modulation unit 26.

FIG. 5 is a flowchart illustrating operation of the optical transmission device 2.

FIG. 6 is a diagram illustrating an example of a configuration of an optical reception device 3 according to the first embodiment.

FIG. 7 is a diagram illustrating an example of a configuration of a signal processing unit 33.

FIG. 8 is a flowchart illustrating operation of the optical reception device 3.

FIG. 9 is a diagram illustrating an example of the configuration of the optical transmission device 2 according to a second embodiment.

FIG. 10 is a diagram illustrating an example of a relationship between a modulation degree of an intensity modulation signal and reception sensitivity.

### DESCRIPTION OF EMBODIMENTS

Hereinafter, embodiments of the present invention will be described with reference to the drawings.

### First Embodiment

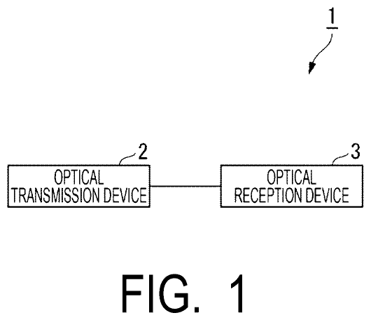

FIG. 1 is a diagram illustrating an example of a configuration of an optical communication system 1 according to a first embodiment. The optical communication system 1 includes an optical transmission device 2 and an optical reception device 3. The optical transmission device 2 transmits an optical signal to the optical reception device 3, and the optical reception device 3 receives the transmitted optical signal.

### (Optical Transmission Device)

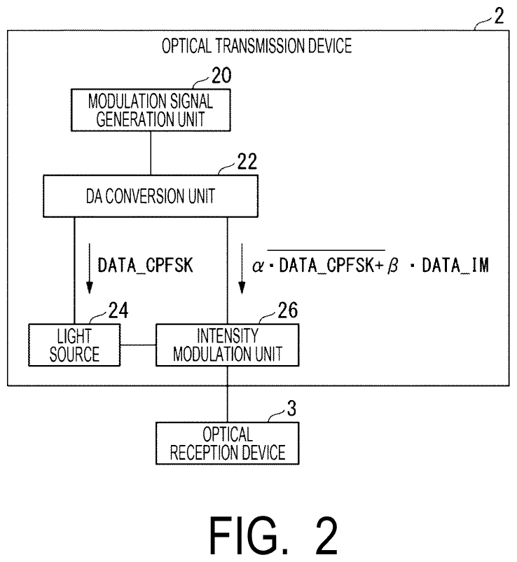

FIG. 2 is a diagram illustrating an example of a configuration of the optical transmission device 2 according to the first embodiment. The optical transmission device 2 includes a modulation signal generation unit 20, a DA conversion unit 22, a light source 24, and an intensity modulation unit 26.

The modulation signal generation unit 20 generates a modulation signal. The DA conversion unit 22 converts the modulation signal into an analog signal. A modulation signal input to the light source 24 and the intensity modulation unit 26 is generated by the modulation signal generation unit 20 and the DA conversion unit 22. The modulation signal generation unit 20 and the DA conversion unit 22 may be an analog signal generator that generates an analog signal.

The modulation signal includes an intensity modulation signal (DATA_IM), a CPFSK signal (DATA_CPFSK), and a CPFSK cancellation signal (Math. 1).

$$\begin{matrix}[ Math . 1 ] & \\ \overline{DATA\_CPFSK} & ( 1 )\end{matrix}$$

Hereinafter, DATA_CPFSK and DATA_IM are described as binary amplitude modulation signals, but DATA_CPFSK and DATA_IM may be amplitude modulation signals with three or more values, and the number of values of DATA_CPFSK and DATA_IM may be independent of each other.

The light source 24 is a direct modulation laser (for example, a distributed feedback (DFB) laser). The light source 24 outputs a signal modulated on the basis of the CPFSK signal.

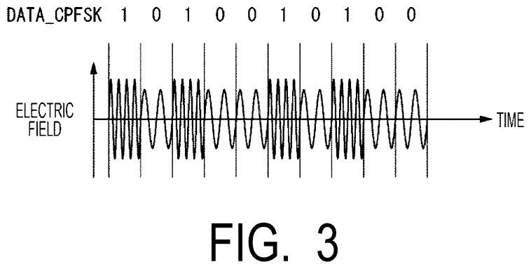

FIG. 3 is a diagram illustrating an electric field of a signal generated by the light source 24. Here, a polarized wave of the signal output from the light source 24 is assumed to be a linearly polarized wave, the output linearly polarized wave is defined as an X polarized wave, and a polarization axis orthogonal to the X polarized wave is defined as a Y polarized wave. An electric field E_{sig1} of the signal output from the light source 24 is expressed by Formula (2).

$$\begin{matrix}[ Math . 2 ] & \\ {E}_{sig 1} = {A}_{m\_CPFSK} {e}^{j ( {ω}_{m\_CPFSK} t - {θ}_{0} )} & ( 2 )\end{matrix}$$

In Formula (2), E_{sig} represents an electric field, A_{m_CPFSK} represents an intensity modulation component generated by the light source 24, ω_{m_CPFSK} represents an angular frequency of frequency-modulated signal light, t represents time, and θ₀ represents a phase that does not change with time.

Amplitude of A_{m_CPFSK} may vary depending on a value of the CPFSK signal. That is, according to CPFSK modulation, intensity modulation of a different magnitude may be performed depending on the value of the CPFSK signal.

The intensity modulation unit 26 performs intensity modulation on the signal output from the light source 24 on the basis of a cancellation CPFSK signal and the intensity modulation signal. The intensity modulation unit 26 performs intensity modulation on the basis of a modulation signal represented by Formula (3).

$$\begin{matrix}[ Math . 3 ] & \\ α \overline{DATA\_CPFSK} + βDATA\_IM & ( 3 )\end{matrix}$$

Here, a is a coefficient that sets a degree of modulation of a signal to be applied to an external intensity modulator for cancelling the intensity modulation component by the light source 24. Here, B is a coefficient that sets a modulation degree of the intensity modulation signal to any value. By the intensity modulation based on the cancellation CPFSK signal, amplitude of the signal output from the light source 24 is a constant value. By intensity modulation based on the intensity modulation signal, a frequency modulation component is left and intensity modulation is performed.

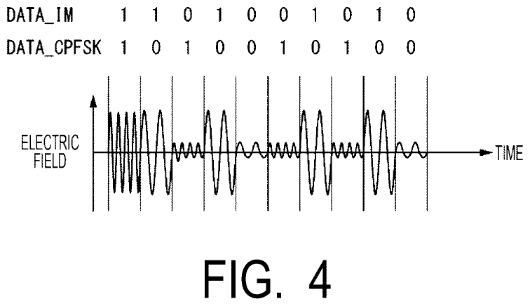

FIG. 4 is a diagram illustrating an electric field of a signal output by the intensity modulation unit 26. In a case where the CPFSK signal and the intensity modulation signal are binary signals, a 4-value modulation signal is applied to the intensity modulation unit 26.

An electric field E_{sig2} of the signal output from the intensity modulation unit 26 is expressed by Formula (4).

$$\begin{matrix}[ Math . 4 ] & \\ {E}_{sig 2} = {A}_{m\_IM} {e}^{j ( {ω}_{m\_CPFSK} t - {θ}_{0} )} & ( 4 )\end{matrix}$$

In Formula (4), A_{m_IM} is a component subjected to intensity modulation by the intensity modulation signal.

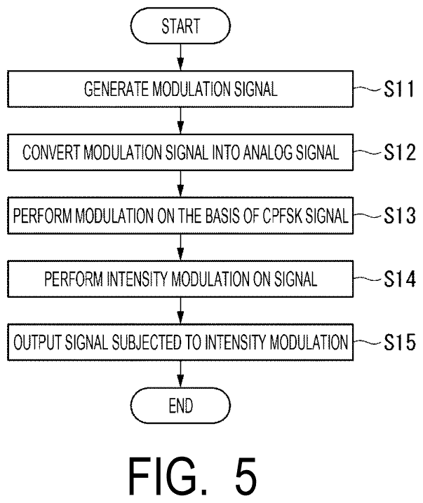

FIG. 5 is a flowchart illustrating operation of the optical transmission device 2. First, the modulation signal generation unit 20 generates a modulation signal (step S11). The DA conversion unit 22 converts the modulation signal into an analog signal (step S12). The light source 24 modulates the signal on the basis of the CPFSK signal (step S13). The intensity modulation unit 26 performs intensity modulation on the signal output from the light source 24 on the basis of the cancellation CPFSK signal and the intensity modulation signal (step S14). Thereafter, the intensity modulation unit 26 outputs the signal subjected to intensity modulation to the optical reception device 3 (step S15).

### (Optical Reception Device)

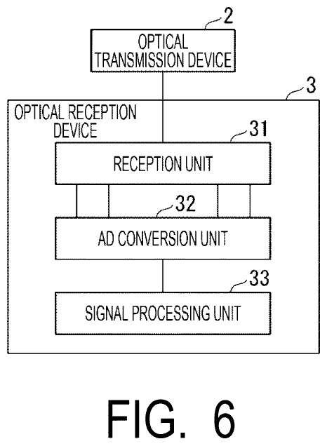

FIG. 6 is a diagram illustrating an example of a configuration of the optical reception device 3 according to the first embodiment. The optical reception device 3 includes a reception unit 31, an AD conversion unit 32, and a signal processing unit 33.

The reception unit 31 is a general polarization/phase diversity receiver, and performs polarization separation and phase separation on a signal received from the optical transmission device 2. The AD conversion unit 32 converts the signal separated by the reception unit 31 into a digital signal. The signal processing unit 33 processes the signal converted by the AD conversion unit 32.

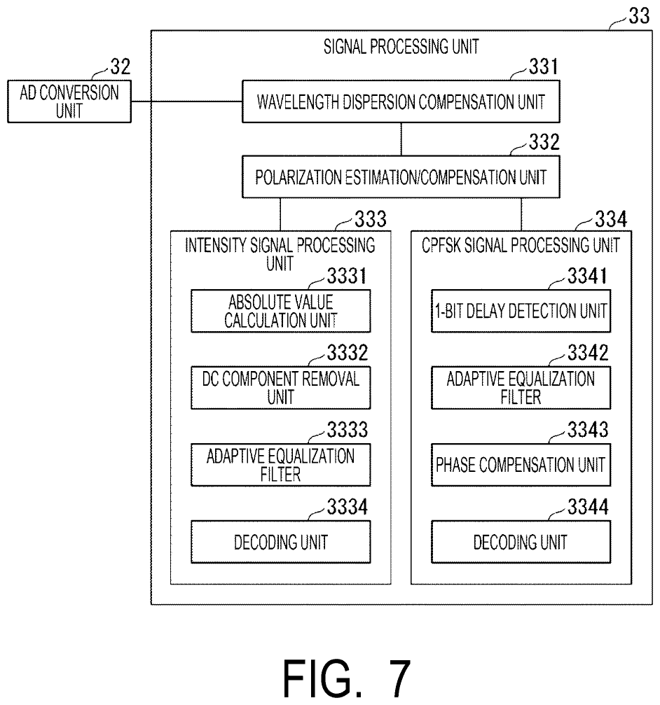

FIG. 7 is a diagram illustrating an example of a configuration of the signal processing unit 33. The signal processing unit 33 includes a wavelength dispersion compensation unit 331, a polarization estimation/compensation unit 332, an intensity signal processing unit 333, and a CPFSK signal processing unit 334.

The wavelength dispersion compensation unit 331 estimates and compensates for wavelength dispersion accompanying fiber propagation of a signal. The polarization estimation/compensation unit 332 estimates and compensates for a polarization rotation component accompanying fiber propagation of the signal on which compensation is performed by the wavelength dispersion compensation unit 331. The intensity signal processing unit 333 processes the signal on which compensation is performed by the polarization estimation/compensation unit 332. The CPFSK signal processing unit 334 processes the signal on which compensation is performed by the polarization estimation/compensation unit 332.

The intensity signal processing unit 333 includes an absolute value calculation unit 3331, a DC component removal unit 3332, an adaptive equalization filter 3333, and a decoding unit 3334. The absolute value calculation unit 3331 calculates an absolute value of a complex signal. As a result, the signal includes only intensity information. The DC component removal unit 3332 removes a DC component of the absolute value calculated by the absolute value calculation unit 3331. The adaptive equalization filter 3333 compensates for waveform degradation of the signal from which the DC component has been removed by the DC component removal unit 3332. The decoding unit 3334 decodes the signal on which compensation is performed by the adaptive equalization filter 3333.

The CPFSK signal processing unit 334 includes a 1-bit delay detection unit 3341, an adaptive equalization filter 3342, a phase compensation unit 3343, and a decoding unit 3344. The 1-bit delay detection unit 3341 performs 1-bit delay detection of a signal. The adaptive equalization filter 3342 compensates for waveform degradation of the signal in which 1-bit delay is detected. The phase compensation unit 3343 compensates for a phase of the signal on which compensation is performed by the adaptive equalization filter 3342. The decoding unit 3344 decodes the signal on which compensation for the phase is performed. Processing by the CPFSK signal processing unit 334 is a normal CPFSK signal processing method described in Non Patent Literature 2.

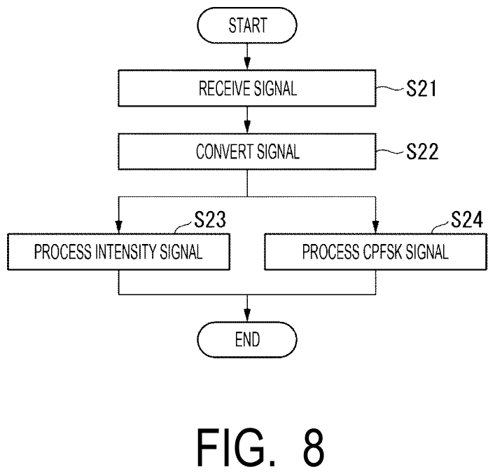

FIG. 8 is a flowchart illustrating operation of the optical reception device 3. First, the reception unit 31 receives a signal from the optical transmission device 2 (step S21). Next, the AD conversion unit 32 converts the analog signal into a digital signal (step S22). Next, the signal processing unit 33 processes an intensity signal (step S23) and processes the CPFSK signal (step S24).

As described above, in the optical transmission device 2, the light source 24 modulates a signal on the basis of the CPFSK signal, and the intensity modulation unit 26 performs intensity modulation that cancels an intensity modulation component generated by modulation based on the CPFSK signal and intensity modulation based on the intensity modulation signal. As a result, not only a frequency per wavelength of a signal but also magnitude of intensity can be used for signal transmission, and a transmission speed per wavelength of the signal can be increased.

### Second Embodiment

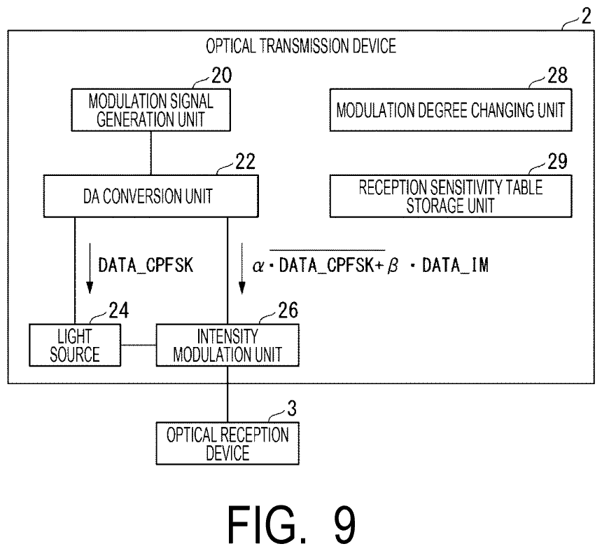

FIG. 9 is a diagram illustrating an example of the configuration of the optical transmission device 2 according to a second embodiment. The optical transmission device 2 according to the second embodiment includes a modulation degree changing unit 28 and a reception sensitivity table storage unit 29 in addition to the optical transmission device 2 according to the first embodiment.

The modulation degree changing unit 28 changes a modulation degree of an intensity modulation signal generated by the modulation signal generation unit 20. The modulation degree changing unit 28 changes the modulation degree of the intensity modulation signal on the basis of, for example, a reception sensitivity table stored in the reception sensitivity table storage unit 29. The reception sensitivity table indicates reception sensitivity for each of combinations of a modulation scheme, a modulation multilevel degree, a symbol rate, a modulation degree, a receiver configuration, and a transmission distance.

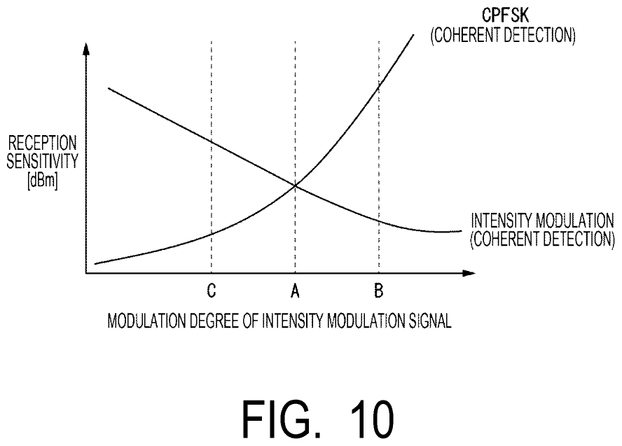

FIG. 10 is a diagram illustrating an example of a relationship between the modulation degree of the intensity modulation signal and the reception sensitivity. When the modulation degree of the intensity modulation signal is increased, the reception sensitivity when the intensity modulation signal is received is improved, but the reception sensitivity when the CPFSK signal is received is degraded. For example, in a case where a digital coherent receiver simultaneously receives the intensity modulation signal and the CPFSK signal as in the optical reception device 3, the intensity modulation signal and the CPFSK signal need to have equivalent reception sensitivity. That is, the modulation degree is desirably A.

In addition, for example, in a case where an intensity modulation receiver that receives only the intensity modulation signal and a coherent receiver that receives the intensity modulation signal and the CPFSK signal simultaneously receive the signals, and a signal loss between a transmitter and the intensity modulation receiver is large and there is a margin in the reception sensitivity of the CPFSK signal, the modulation degree may be set to B, and sensitivity of the intensity modulation signal may be improved.

In addition, for example, in a case where the intensity modulation receiver that receives only the intensity modulation signal and the coherent receiver that receives the intensity modulation signal and the CPFSK signal simultaneously receive the signals, and there is a margin in the reception sensitivity of the intensity modulation signal, the modulation degree may be set to C, and sensitivity of the CPFSK signal may be improved.

That is, on the basis of the reception sensitivity indicated by the reception sensitivity table, the modulation degree changing unit 28 can change the modulation degree so that, for example, the reception sensitivity of the intensity modulation signal and the reception sensitivity of the CPFSK signal are equivalent to each other, and can change the modulation degree so that the intensity modulation signal or the CPFSK signal has any reception sensitivity.

### Other Embodiments

Although the embodiments of the present invention have been described in detail with reference to the drawings, the specific configuration is not limited to the above, and various design changes and the like can be made without departing from the gist of the present invention.

For example, in the above-described embodiments, the modulation signal generation unit 20 generates the intensity modulation signal, the CPFSK signal, and the CPFSK cancellation signal, but the present invention is not limited thereto. For example, a plurality of the modulation signal generation units 20 may generate the intensity modulation signal, the CPFSK signal, and the CPFSK cancellation signal, respectively. In addition, a plurality of the DA conversion units 22 respectively corresponding to the plurality of modulation signal generation units 20 may be provided in the optical transmission device 2.

In addition, two intensity modulation units 26 corresponding to the intensity modulation signal and the CPFSK cancellation signal may be provided in the optical transmission device 2, and the intensity modulation units 26 may perform the intensity modulation respectively on the basis of the intensity modulation signal and the CPFSK cancellation signal.

### REFERENCE SIGNS LIST

1 Optical communication system
2 Optical transmission device
20 Modulation signal generation unit
22 DA conversion unit
24 Light source
26 Intensity modulation unit
28 Modulation degree changing unit
29 Reception sensitivity table storage unit
3 Optical reception device
31 Reception unit
32 AD conversion unit
33 Signal processing unit
331 Wavelength dispersion compensation unit
332 Polarization estimation/compensation unit
333 Intensity signal processing unit
3331 Absolute value calculation unit
3332 DC component removal unit
3333 Adaptive equalization filter
3334 Decoding unit
3341 1-bit delay detection unit
3342 Adaptive equalization filter
3343 Phase compensation unit
3344 Decoding unit

1. An optical transmission device comprising:
a modulation signal generator configured to generate an intensity modulation signal and a continuous phase frequency shift keying (CPFSK) signal;
a light source configured to output a signal modulated by the CPFSK signal; and
an intensity modulator configured to perform intensity modulation for canceling an intensity modulation component generated by modulation by the CPFSK signal, and intensity modulation by the intensity modulation signal, on the signal output from the light source.

2. The optical transmission device according to claim 1, further comprising a modulation degree changer configured to change a modulation degree of the intensity modulation signal.

3. An optical communication system comprising:
an optical transmission device including:
a modulation signal generator configured to generate an intensity modulation signal and a continuous phase frequency shift keying (CPFSK) signal;
a light source configured to output a signal modulated by the CPFSK signal; and
an intensity modulator configured to perform intensity modulation for canceling an intensity modulation component generated by modulation by the CPFSK signal, and intensity modulation by the intensity modulation signal, on the signal output from the light source; and
an optical reception device including:
a receiver configured to perform polarization separation and phase separation on a signal received from the optical transmission device; and
a signal processor configured to decode the intensity modulation signal and the CPFSK signal on a basis of signals subjected to the polarization separation and the phase separation.

4. An optical transmission method comprising:
generating an intensity modulation signal and a continuous phase frequency shift keying (CPFSK) signal;
outputting a signal modulated by the CPFSK signal; and
performing intensity modulation for canceling an intensity modulation component generated by modulation by the CPFSK signal, and intensity modulation by the intensity modulation signal, on the signal modulated by the CPFSK signal.
